(19) United States
(12) Patent Application Publication
(10) Pub. No.: US 2018/0341296 A1
(43) Pub. Date: Nov. 29, 2018

(54) SUPPORTING MEMBER AND CASING INCLUDING THE SAME

(71) Applicant: COOLER MASTER TECHNOLOGY INC., New Taipei City (TW)

(72) Inventor: Chia-Hsiang CHI, New Taipei City (TW)

(73) Assignee: COOLER MASTER TECHNOLOGY INC., New Taipei City (TW)

(21) Appl. No.: 15/974,206

(22) Filed: May 8, 2018

(30) Foreign Application Priority Data
May 26, 2017 (TW) 106117748

(51) Int. Cl. G06F 1/18

(52) U.S. Cl. CPC G06F 1/181

(57) ABSTRACT

A casing includes a frame and first, second, third and fourth positioning portions. The frame includes two first and two second frame components connected together at one side thereof. Each first frame component has a first and a second surface. Each second frame component has a third and a fourth surface. The first and the third surfaces form an outer side surface. The second and the fourth surfaces form an inner side surface surrounded by the outer side surface. The first through the fourth positioning portions are respectively on the first through the fourth surfaces. Every adjacent first positioning portions are spaced apart by a first distance. Every adjacent second positioning portions are spaced apart by a second distance being different from the first distance. Every adjacent third positioning portions are spaced apart by the first distance. Every adjacent fourth positioning portions are spaced apart by the second distance.

### CROSS-REFERENCE TO RELATED APPLICATIONS

This non-provisional application claims priority under 35 U.S.C. § 119(a) on Patent Application No(s). 106117748 filed in Taiwan, R.O.C. on May 26, 2017, the entire contents of which are hereby incorporated by reference.

### TECHNICAL FIELD

The disclosure relates to a supporting member and a casing including the same, more particularly to a supporting member which is flexible in assembly and a casing including the same.

### BACKGROUND

In recent years, personal desktop computers have been widely used in workplaces and homes. With the rapid development of technology, computers are now providing multiple functionalities, such as basic document editing, programming, internet surfing and even film playing or gaming, for work and entertainment purposes. As a result, computers are increasingly becoming more essential in any aspect of life.

Generally, a computer is composed of various electronic components and peripherals. The electronic components are usually disposed within a computer casing, and the computer casing can provide protection from physical damage, dust and moisture. As the market becomes diverse, there are more and more options for each electronic component, such that consumers would have various options to build or level up their computer.

However, a conventional computer casing usually has a limited compatibility with the electronic components that can be installed therewithin. For example, the fasteners for the installation of the electronic components are only located in a particular location and are low in quantity. Thus, consumers should buy an electronic component particularly compatible to the casing, or buy a new casing which is compatible to the desired electronic component. This results in a limited option to build a computer. Accordingly, how to increase the compatibility of a computer casing is an important topic in this field.

### SUMMARY

The present disclosure provides a supporting member and a casing including the same, which feature high flexibility in assembly to allow a flexible installation of the electronic components in the casing.

One embodiment of the disclosure provides a casing, which includes a frame, a plurality of first positioning portions, a plurality of second positioning portions, a plurality of third positioning portions and a plurality of fourth positioning portions. The frame includes two first frame components and two second frame components which are connected together and located at one side of the frame. Each of the two first frame components has a first surface and a second surface, and each of the two second frame components has a third surface and a fourth surface. The first surfaces and the third surfaces together form an outer side surface, and the second surfaces and the fourth surfaces together form an inner side surface, wherein the outer side surface surrounds the inner side surface. The plurality of first positioning portions are located on the first surfaces, and the plurality of second positioning portions are located on the second surfaces, wherein every two of the plurality of first positioning portions, which are adjacent to each other, are spaced apart by a first distance, and every two of the plurality of second positioning portions, which are adjacent to each other, are spaced apart by a second distance. The plurality of third positioning portions are located on the third surfaces, and the plurality of fourth positioning portions are located on the fourth surfaces, wherein every two of the plurality of third positioning portions, which are adjacent to each other, are spaced apart by the first distance, and every two of the plurality of fourth positioning portions, which are adjacent to each other, are spaced apart by the second distance. In addition, the first distance is different from the second distance.

One embodiment of the disclosure provides a casing, which includes a frame, a plurality of first positioning portions, a plurality of second positioning portions, a plurality of third positioning portions and a plurality of fourth positioning portions. The frame includes two first frame components and two second frame components which are connected together and located at one side of the frame. The two first frame components and the two second frame components together form an outer side surface and an inner side surface. The outer side surface surrounds the inner side surface, and the outer side surface parallels the inner side surface. The plurality of first positioning portions and the plurality of second positioning portions are located on the two first frame components. The plurality of third positioning portions and the plurality of fourth positioning portions are located on the two second frame components. In addition, the plurality of first positioning portions and the plurality of third positioning portions are located on the outer side surface, and the plurality of second positioning portions and the plurality of fourth positioning portions are located on the inner side surface.

One embodiment of the disclosure provides a supporting member of a casing, which includes a frame component, a plurality of first positioning portions and a plurality of second positioning portions. The frame component includes a column part and at least one extension plate. The column part has a first surface. The at least one extension plate is connected to one side of the column part, and the at least one extension plate has a second surface. The plurality of first positioning portions are located on the first surface. The plurality of second positioning portions are located on the second surface. In addition, a distance between every two of the plurality of first positioning portions, which are adjacent to each other, is different from a distance between every two of the plurality of second positioning portions which are adjacent to each other.

One embodiment of the disclosure provides a supporting member of a casing, which includes a frame component, a plurality of first positioning portions and a plurality of second positioning portions. The frame component includes a column part and at least one extension plate. The column part has a first surface. The at least one extension plate is connected to one side of the column part. The at least one extension plate has a second surface, and the second surface parallels the first surface. The plurality of first positioning portions are located on the first surface. The plurality of second positioning portions are located on the second surface.

One embodiment of the disclosure provides a supporting member of a casing, which includes a frame component, a plurality of first positioning portions and a plurality of second positioning portions. The frame component includes a hollow column and at least two protruding plates. The at least two protruding plates respectively protrude from two different sides of the hollow column. The plurality of first positioning portions and the plurality of second positioning portions are located on the hollow column and respectively aligned in two straight lines. The plurality of third positioning portions and the plurality of fourth positioning portions are located on the two protruding plates and respectively aligned in another two straight lines.

According to the supporting member and the casing including the same as described above, there are the positioning portions located on the inner side surface and the outer side surface of the supporting members, such that the casing can be available for the installation of another assembling component or of other electronic components, such as mother boards, hard disc drives or fans. That is, the supporting member improves the flexibility in assembly.

Moreover, in some other embodiments, there are the positioning portions located on the outer side surface, such that the frame becomes compatible with cover plates of various configurations, thereby increasing the compatibility with peripherals.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a perspective view of a casing in accordance with a first embodiment of the disclosure;

FIGS. 2A and 2B are exploded views of the casing in FIG. 1;

FIG. 3 is a partial view of supporting members in FIG. 1;

FIG. 4 is a side view of the casing in FIG. 1;

FIG. 5 is a perspective and cross-sectional view of a supporting member in accordance with a second embodiment of the disclosure;

FIG. 6 is a partial view of supporting members in accordance with a third embodiment of the disclosure;

FIG. 7 is a perspective and cross-sectional view of a supporting member in accordance with a fourth embodiment of the disclosure;

FIGS. 8A and 8B are exploded views of a casing in accordance with a fifth embodiment of the disclosure;

FIG. 9 is a partial view of supporting members in FIG. 8A; and

FIG. 10 is a perspective and cross-sectional view of a supporting member in accordance with a sixth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

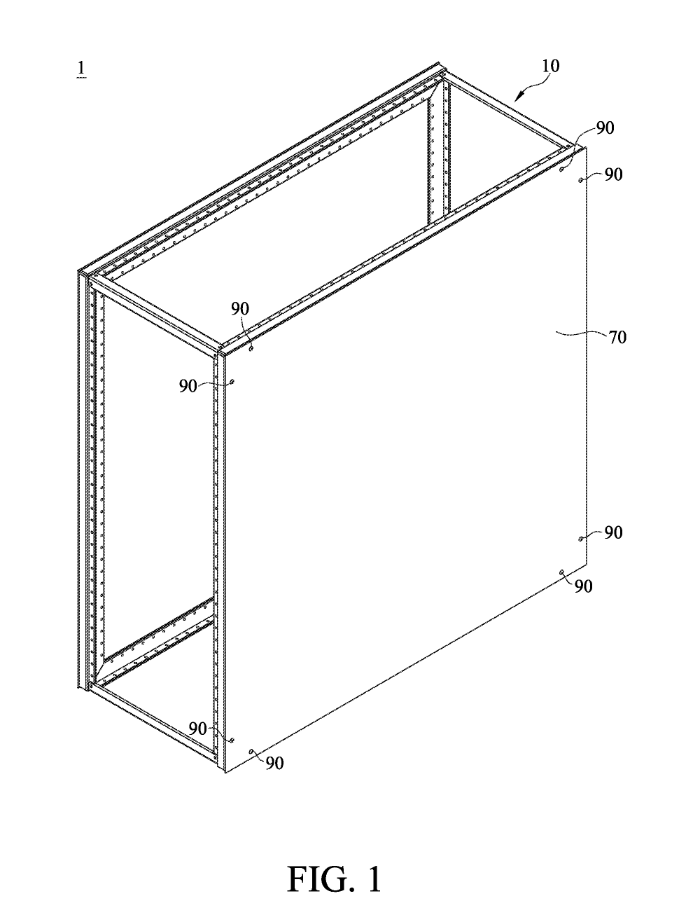

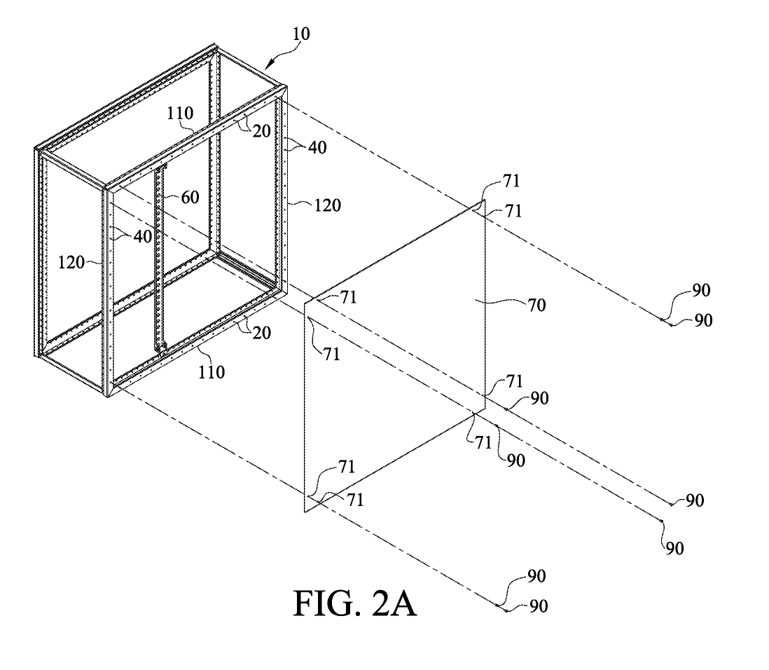

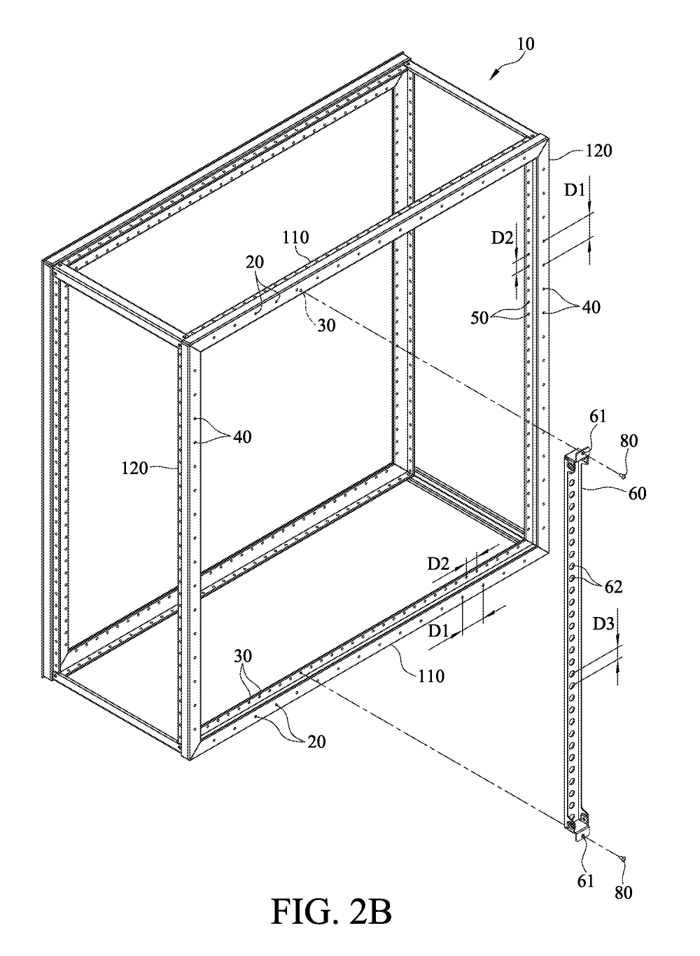

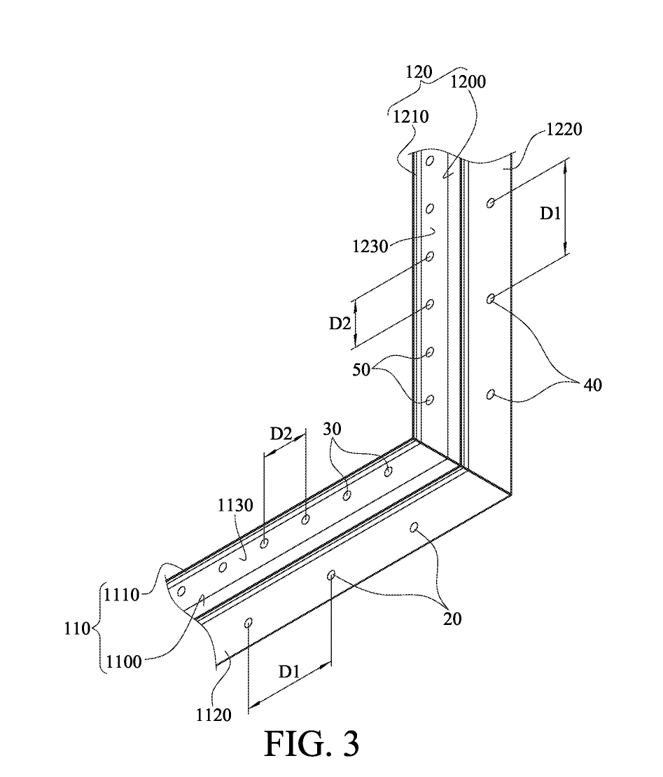

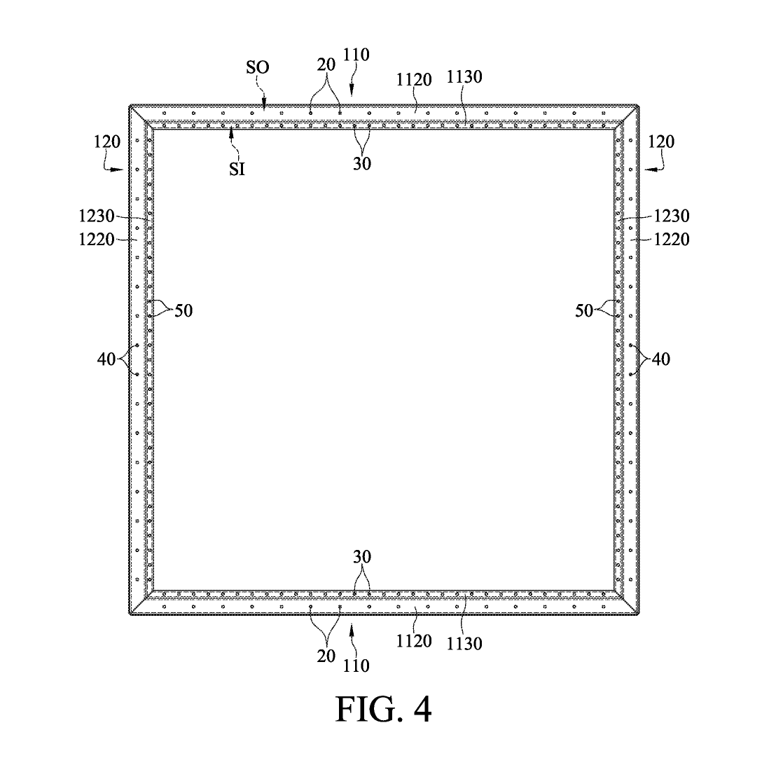

Please refer to FIG. 1 to FIG. 4. FIG. 1 is a perspective view of a casing in accordance with a first embodiment of the disclosure, FIGS. 2A and 2B are exploded views of the casing in FIG. 1, FIG. 3 is a partial view of supporting members in FIG. 1, and FIG. 4 is a side view of the casing in FIG. 1.

In this embodiment, a casing 1 is provided, and the casing 1 includes a frame 10, a plurality of first positioning portions 20, a plurality of second positioning portions 30, a plurality of third positioning portions 40, a plurality of fourth positioning portions 50, an assembling component 60, a cover plate 70, two first connecting members 80 and a plurality of second connecting members 90.

The frame 10 includes two first frame components 110 and two second frame components 120 which are connected together and located at one side of the frame 10. Each of the first frame components 110 includes a column part 1100 and a first extension plate 1110 which are of a single piece made from an aluminum extrusion. The first extension plate 1110 is connected to one side of the column part 1100. Each of the column parts 1100 has a first surface 1120, and each of the first extension plates 1110 has a second surface 1130. Each of the second frame components 120 includes a column part 1200 and a second extension plate 1210 which are of a single piece made from an aluminum extrusion. The second extension plate 1210 is connected to one side of the column part 1200. Each of the column parts 1200 has a third surface 1220, and each of the second extension plates 1210 has a fourth surface 1230. In addition, the first surfaces 1120 and the third surfaces 1220 together form an outer side surface SO, the second surfaces 1130 and the fourth surfaces 1230 together form an inner side surface SI, and the outer side surface SO surrounds and parallels the inner side surface SI.

The first positioning portions 20, the second positioning portions 30, the third positioning portions 40 and the fourth positioning portions 50 are holes. The first positioning portions 20 are located on the first surfaces 1120, and the second positioning portions 30 are located on the second surfaces 1130. Every two of the first positioning portions 20, which are adjacent to each other, are spaced apart by a first distance D1. Every two of the second positioning portions 30, which are adjacent to each other, are spaced apart by a second distance D2. The third positioning portions 40 are located on the third surfaces 1220, and the fourth positioning portions 50 are located on the fourth surfaces 1230. Every two of the third positioning portions 40, which are adjacent to each other, are spaced apart by the first distance D1. Every two of the fourth positioning portions 50, which are adjacent to each other, are spaced apart by the second distance D2.

In this embodiment, the first distance D1 is larger than the second distance D2, but the present disclosure is not limited thereto. In other embodiments, the first distance D1 may be smaller than the second distance D2.

Furthermore, in the present disclosure, the first positioning portions 20, the second positioning portions 30, the third positioning portions 40 and the fourth positioning portions 50 are not restricted to be holes. In other embodiments, these positioning portions may be hooks.

Each of the first frame components 110 and the first positioning portions 20 and the second positioning portions 30 thereon are configured to be a first supporting member. Each of the second frame components 120 and the third positioning portions 40 and the fourth positioning portions 50 thereon are configured to be a second supporting member. In this embodiment, each of the first supporting members is orthogonal to each of the second supporting members, but the present disclosure is not limited thereto.

The assembling component 60 has two connecting structures 61 at either end, and the two connecting structures 61 are, for example, two through holes, and respectively correspond to at least one of the second positioning portions 30 on each first frame component 110. The connecting structure 61 can be fixed on the second positioning portion 30 by the first connecting member 80. In addition, the assembling component 60 further includes a plurality of perforations 62. Every two of the perforations 62, which are adjacent to each other, are spaced apart by a third distance D3, and the third distance D3 is equal to the second distance D2. The first connecting member 80 is, for example, a bolt or a fixing plug.

In this embodiment, the two connecting structures 61 are through holes, but the present disclosure is not limited thereto. In other embodiments, the connecting structures may be slots configured to be engaged with the positioning portions which are hooks.

The cover plate 70 has a plurality of through holes 71, and the second connecting members 90 are respectively disposed through the through holes 71 and fixed to the first positioning portions 20 and the third positioning portions 40. The second connecting member 90 is, for example, a bolt or a fixing plug.

In this embodiment, the assembling component 60 is able to be fixed on the inner side surface SI via the connection of the connecting structures 61 and two of the second positioning portions 30 on the first frame components 110, and the cover plate 70 is able to be fixed on the outer side surface SO via connection of the through holes 71 and some of the third positioning portions 40. It is noted that the rest second positioning portions 30 and the third positioning portions 40 can be used for the installation of another assembling component or other electronic components, such as mother boards, hard disc drives or fans. Also worthy to mention is that such electronic components can also be fixed on the casing 1 via the holes (the fourth positioning portions 50) on the inner side surface SI and the perforations 62 on the assembling component 60, and this allows the electronic components of different sizes to be installed on the casing, thereby further improving the flexibility in assembly.

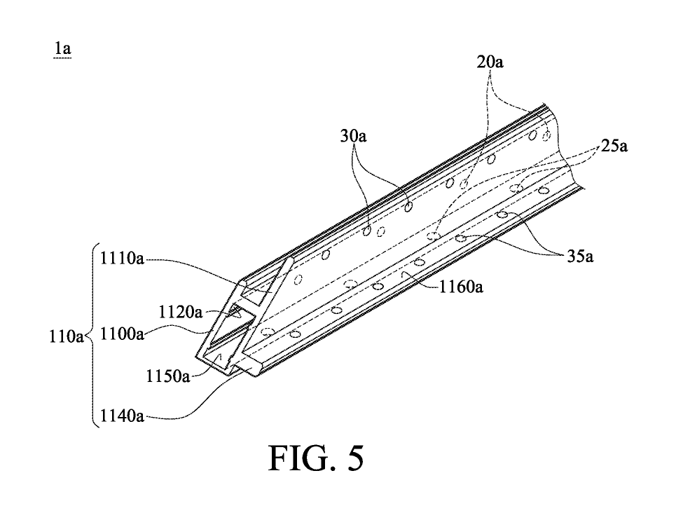

However, the present disclosure is not limited to the first embodiment. In some other embodiments, every side of the frame may all have a configuration similar or identical to the aforementioned configuration in the previous embodiment. To achieve this, each supporting member should have positioning portions respectively located on adjacent sides of the frame. In detail, please refer to FIG. 5, which is a perspective and cross-sectional view of a supporting member in accordance with a second embodiment of the disclosure.

Since supporting members are similar in structure, only one of the supporting members is described in the following paragraphs.

In this embodiment, a casing 1a is provided. The casing 1a further includes a plurality of first side positioning portions 25a and a plurality of second side positioning portions 35a. The first side positioning portions 25a and the second side positioning portions 35a are, for example, holes. The casing 1a includes a first frame component 110a which further including a column part 1100a and two first extension plates 1110a and 1140a. In detail, the first extension plates 1110a and 1140a are respectively connected to adjacent sides of the column part 1100a. The column part 1100a further includes a first side surface 1150a connected to a first surface 1120a. The first extension plate 1140a has a second side surface 1160a. The first side positioning portions 25a are located on the first side surface 1150a, and the second side positioning portions 35a are located on the second side surface 1160a. A distance between every two of the first side positioning portions 25a, which are adjacent to each other, is larger than a distance between every two of the second side positioning portions 35a which are adjacent to each other.

It is noted that the first frame component 110a and a plurality of first positioning portions 20a, the first side positioning portions 25a, a plurality of second positioning portions 30a and the second side positioning portions 35a thereon are configured to be a supporting member.

Furthermore, in this embodiment, the distance between every two of the first side positioning portions 25a, which are adjacent to each other, is equal to a distance between every two of the first positioning portions 20a which are adjacent to each other, and the distance between every two of the second side positioning portions 35a, which are adjacent to each other, is equal to a distance between every two of the second positioning portions 30a which are adjacent to each other, but the present disclosure is not limited thereto. In other embodiments, the distance between every two of the first side positioning portions, which are adjacent to each other, may not equal to the distance between every two of the first positioning portions which are adjacent to each other, and the distance between every two of the second side positioning portions, which are adjacent to each other, may not equal to the distance between every two of the second positioning portions which are adjacent to each other.

By the supporting members, the assembling component and other electronic components, such as mother boards, hard disc drives or fans, as mentioned in the previous embodiment are allowed to be disposed on all sides of the casing 1a. With such flexibility, those to be installed on the casing 1a can be mounted without mechanical interference, thereby obtaining a better space utilization. Also worthy to mention is that such configuration allows the casing 1a to be placed vertically or horizontally to fit in various environments.

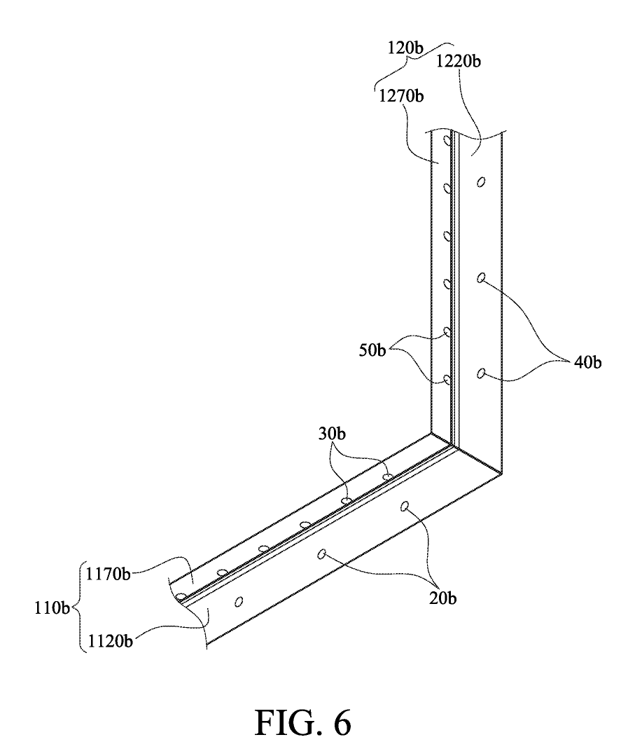

In the first embodiment, the outer side surface SO is parallel to the inner side surface SI, but the present disclosure is not limited thereto. In other embodiments, the outer side surface may be orthogonal to the inner side surface. Please refer to FIG. 6, which is a partial view of supporting members in accordance with a third embodiment of the disclosure.

In this embodiment, a first frame component 110b has a first surface 1120b and a third side surface 1170b adjacent to each other, and the first surface 1120b is orthogonal to the third side surface 1170b. Furthermore, a second frame components 120b has a third surface 1220b and a fourth side surface 1270b adjacent to each other, and the third surface 1220b is orthogonal to the fourth side surface 1270b. A plurality of first positioning portions 20b are located on the first surface 1120b, a plurality of second positioning portions 30b are located on the third side surface 1170b, a plurality of third positioning portions 40b are located on the third surface 1220b, and a plurality of fourth positioning portions 50b are located on the fourth side surface 1270b. The first surface 1120b and the third surface 1220b together form an outer side surface, the third side surface 1170b and the fourth side surface 1270b together form an inner side surface, and the outer side surface surrounds and is orthogonal to the inner side surface. In this case, an assembling component (not shown), which is configured to be disposed on the inner side surface, has connecting structures at two ends thereof for the engagement with the positioning portions on the inner side surface.

It is noted that the first frame component 110b and the first positioning portions 20b and the second positioning portions 30b thereon are configured to be a first supporting member. The second frame components 120b and the third positioning portions 40b and the fourth positioning portions 50b thereon are configured to be a second supporting member.

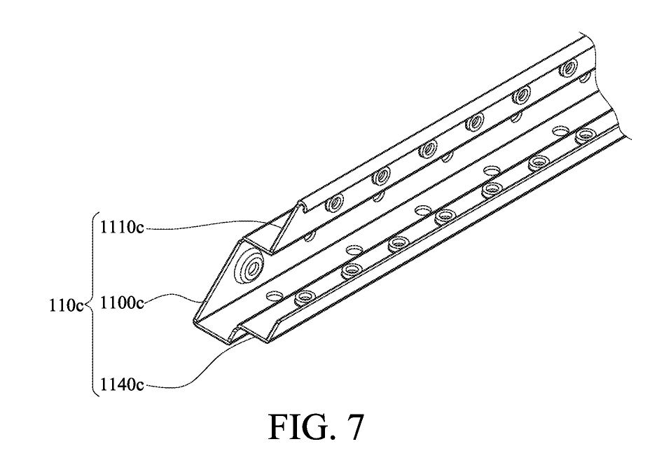

In the aforementioned embodiments, the column part and the extension plates are made from an aluminum extrusion, but the present disclosure is not limited thereto. Please refer to FIG. 7, which is a perspective and cross-sectional view of a supporting member in accordance with a fourth embodiment of the disclosure. FIG. 7 is taken in a view angle similar to that of FIG. 5. In this embodiment, a supporting member includes a column part 1100c and two extension plates 1110c, 1140c, which are of a single piece which is formed by bending a sheet metal so as to be formed into a frame component 110c.

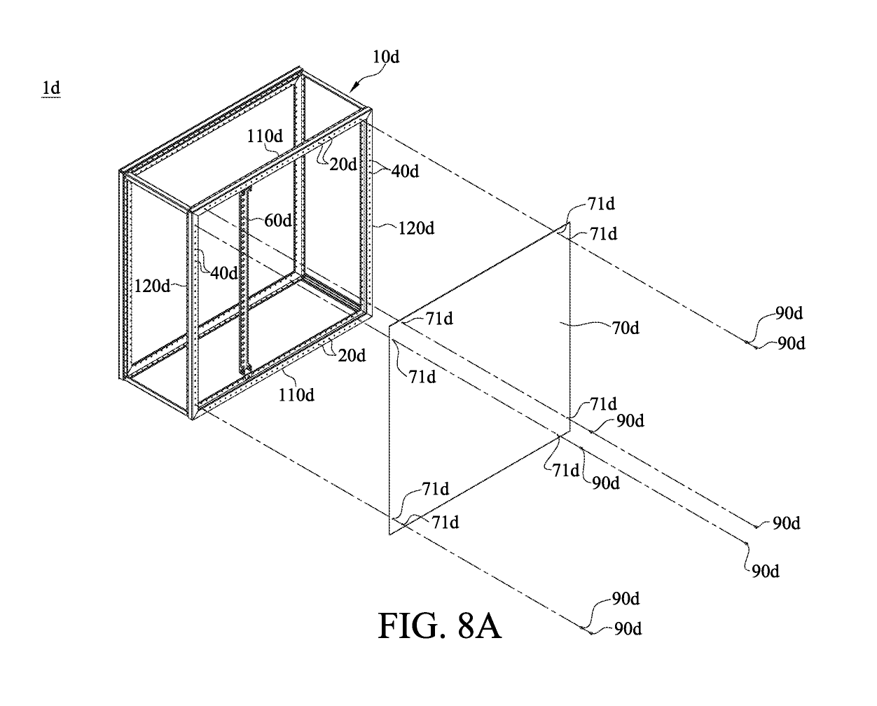

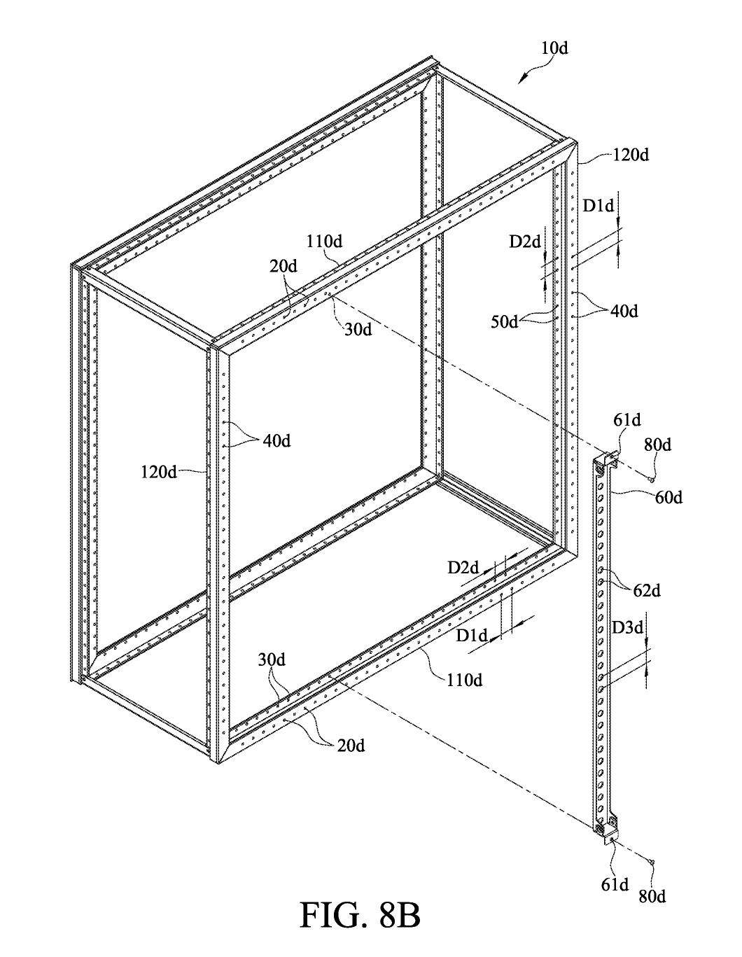

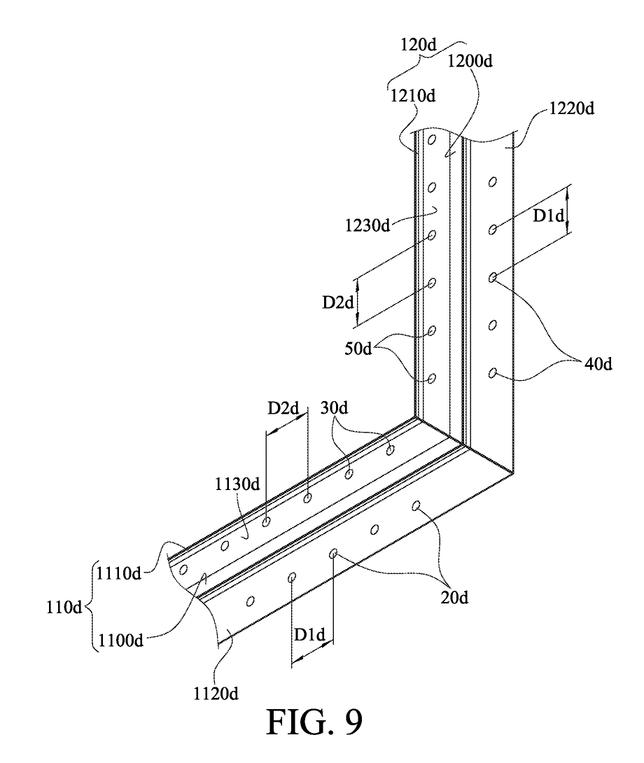

In the aforementioned embodiments, the distance between every two of the positioning portions on the outer side surface, which are adjacent to each other, is different from the distance between every two of the positioning portions on the inner side surface, which are adjacent to each other, but the present disclosure is not limited thereto. Please refer to FIG. 8A to FIG. 9, FIGS. 8A and 8B are exploded views of a casing in accordance with a fifth embodiment of the disclosure, and FIG. 9 is a partial view of supporting members in FIG. 8A.

In this embodiment, a casing 1d is provided, and the casing 1d includes a frame 10d, a plurality of first positioning portions 20d, a plurality of second positioning portions 30d, a plurality of third positioning portions 40d, a plurality of fourth positioning portions 50d, an assembling component 60d, a cover plate 70d, two first connecting members 80d and a plurality of second connecting members 90d.

The frame 10d includes two first frame components 110d and two second frame components 120d which are connected together and located at one side of the frame 10d. Each of the first frame components 110d includes a column part 1100d and a first extension plate 1110d which are of a single piece made from an aluminum extrusion. The first extension plate 1110d is connected to one side of the column part 1100d. Each of the column part 1100d has a first surface 1120d, and each of the first extension plates 1110d has a second surface 1130d. Each of the second frame components 120d includes a column part 1200d and a second extension plate 1210d which are of a single piece made from an aluminum extrusion. The second extension plate 1210d is connected to one side of the column part 1200d. Each of the column part 1200d has a third surface 1220d, and each of the second extension plates 1210d has a fourth surface 1230d. In addition, the first surfaces 1120d and the third surfaces 1220d together form an outer side surface, the second surfaces 1130d and the fourth surfaces 1230d together form an inner side surface, the outer side surface surrounds and parallels the inner side surface, and there is a step between the outer side surface and the inner side surface.

The first positioning portions 20d, the second positioning portions 30d, the third positioning portions 40d and the fourth positioning portions 50d are holes. The first positioning portions 20d are located on the first surfaces 1120d, and the second positioning portions 30d are located on the second surfaces 1130d. Every two of the first positioning portions 20d, which are adjacent to each other, are spaced apart by a first distance D1d. Every two of the second positioning portions 30d, which are adjacent to each other, are spaced apart by a second distance D2d. The third positioning portions 40d are located on the third surfaces 1220d, and the fourth positioning portions 50d are located on the fourth surfaces 1230d. Every two of the third positioning portions 40, which are adjacent to each other, are spaced apart by the first distance D1d. Every two of the fourth positioning portions 50d, which are adjacent to each other, are spaced apart by the second distance D2d. In this embodiment, the first distance D1d is equal to the second distance D2d.

Each of the first frame components 110d and the first positioning portions 20d and the second positioning portions 30d thereon are configured to be a first supporting member, and each of the second frame components 120d and the third positioning portions 40d and the fourth positioning portions 50d thereon are configured to be a second supporting member. In this embodiment, the first supporting member is orthogonal to the second supporting member.

The assembling component 60d has two connecting structures 61d at either end, and the two connecting structure 61d are, for example, two through holes and respectively correspond to at least one of the second positioning portions 30d on each first frame component 110d. The two connecting structures 61d can be fixed on the second positioning portion 30d by the first connecting member 80d. In addition, the assembling component 60d further includes a plurality of perforations 62d. Every two of the perforations 62d, which are adjacent to each other, are spaced apart by a third distance D3d, and the third distance D3d is equal to the second distance D2d.

The cover plate 70d has a plurality of through holes 71d, and the second connecting members 90d are respectively disposed through the through holes 71d and fixed to the first positioning portions 20d and the third positioning portions 40d.

In this embodiment, the first distance D1d is equal to the second distance D2d, thus the positioning portions on the outer side surface, which are adjacent to each other, are spaced apart by a relatively small distance. As such, the frame 10d is compatible with cover plates of various configurations, thereby increasing the compatibility with peripherals.

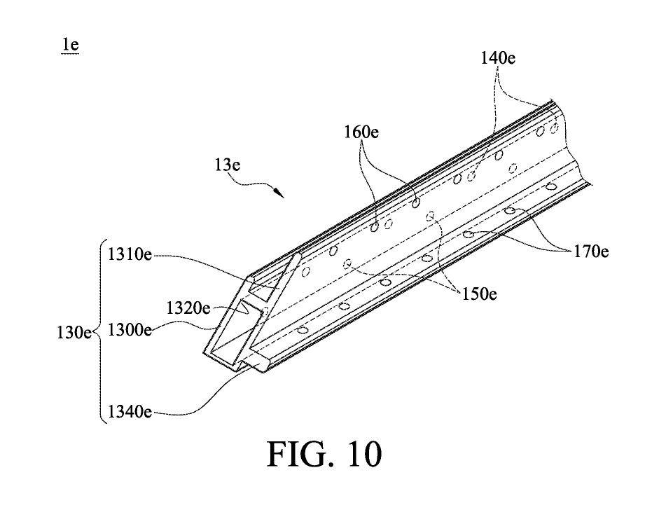

In the second embodiment, the first positioning portions 20a and the first side positioning portions 25a are respectively located on two different surfaces of the column part 1100a, but the present disclosure is note limited thereto. Please refer to FIG. 10, which is a perspective and cross-sectional view of a supporting member in accordance with a sixth embodiment of the disclosure.

In this embodiment, each supporting member 13e of a casing 1e includes a frame component 130e, a plurality of first positioning portions 140e, a plurality of second positioning portions 150e, a plurality of third positioning portions 160e and a plurality of fourth positioning portions 170e. The frame component 130e includes a hollow column 1300e and two protruding plates 1310e and 1340e. The hollow column 1300e has a first surface 1320e. The two protruding plates 1310e and 1340e respectively protrude from two different sides of the hollow column 1300e. The first positioning portions 140e and the second positioning portions 150e are located on the first surface 1320e of the hollow column 1300e and respectively aligned in two straight lines. The third positioning portions 160e are located on the protruding plates 1310e and aligned in another straight line. The fourth positioning portions 170e are located on the protruding plates 1340e and aligned in yet another straight line.

In this embodiment, the hollow column 1300e has positioning portions aligned in the two straight lines on the first surface 1320e, but the present disclosure is not limited thereto. In other embodiments, the other sides of the hollow column may each have positioning portions aligned in a straight line, or the first surface of the hollow column may have positioning portions aligned in three straight lines.

According to the supporting member and the casing including the same as described above, there are the positioning portions located on the inner side surface and the outer side surface of the supporting members, such that the casing can be available for the installation of another assembling component or of other electronic components, such as mother boards, hard disc drives or fans. That is, the supporting member improves the flexibility in assembly.

In addition, such electronic components can also be fixed on the casing via the positioning portions on the inner side surface and the perforations on the supporting members, and this allows the electronic components of different sizes to be installed on the casing, thereby further improving the flexibility.

Furthermore, in some other embodiments, each side of the supporting member has the positioning portions, thus the assembling component and the electronic components are allowed to be disposed on all sides of the casing which has such supporting members. With such flexibility, those to be installed on the casing can be mounted without mechanical interference, thereby obtaining a better space utilization.

Moreover, in some other embodiments, the positioning portions on the outer side surface are spaced by a smaller distance, such that the frame becomes compatible with cover plates of various configurations, thereby increasing the compatibility with peripherals.

The embodiments were chosen and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

What is claimed is:

1. A casing, comprising:
a frame, comprising two first frame components and two second frame components which are connected together and located at one side of the frame, each of the two first frame components having a first surface and a second surface, each of the two second frame components having a third surface and a fourth surface, the first surfaces and the third surfaces together forming an outer side surface, the second surfaces and the fourth surfaces together forming an inner side surface, and the outer side surface surrounding the inner side surface;
a plurality of first positioning portions and a plurality of second positioning portions, the plurality of first positioning portions being located on the first surfaces, the plurality of second positioning portions being located on the second surfaces, wherein every two of the plurality of first positioning portions, which are adjacent to each other, are spaced apart by a first distance, and every two of the plurality of second positioning portions, which are adjacent to each other, are spaced apart by a second distance; and
a plurality of third positioning portions and a plurality of fourth positioning portions, the plurality of third positioning portions being located on the third surfaces, the plurality of fourth positioning portions being located on the fourth surfaces, wherein every two of the plurality of third positioning portions, which are adjacent to each other, are spaced apart by the first distance, and every two of the plurality of fourth positioning portions, which are adjacent to each other, are spaced apart by the second distance;
wherein the first distance is different from the second distance.

2. The casing according to claim 1, wherein the first distance is larger than the second distance.

3. The casing according to claim 1, further comprising an assembling component, wherein the assembling component has two connecting structures respectively at two ends thereof, and the two connecting structures respectively correspond to at least one of the second positioning portions located on the two first frame components.

4. The casing according to claim 3, further comprising two first connecting members, wherein the two connecting structures are two through holes, and the two first connecting members are respectively disposed through the two through holes and mounted on at least one of the second positioning portions.

5. The casing according to claim 3, wherein the assembling component further comprises a plurality of perforations, every two of the plurality of perforations, which are adjacent to each other, are spaced apart by a third distance, and the third distance is equal to the second distance.

6. The casing according to claim 4, further comprising a cover plate and a plurality of second connecting members, wherein the cover plate has a plurality of through holes, and the plurality of second connecting members are respectively disposed through the plurality of through holes of the cover plate and mounted on the plurality of first positioning portions and the plurality of third positioning portions.

7. The casing according to claim 1, wherein each of the first frame components is orthogonal to each of the second frame components.

8. The casing according to claim 1, wherein the plurality of first positioning portions, the plurality of second positioning portions, the plurality of third positioning portions and the plurality of fourth positioning portions are holes.

9. The casing according to claim 1, wherein the plurality of first positioning portions, the plurality of second positioning portions, the plurality of third positioning portions and the plurality of fourth positioning portions are hooks.

10. A casing, comprising:
a frame, comprising two first frame components and two second frame components which are connected together and located at one side of the frame, the two first frame components and the two second frame components together forming an outer side surface and an inner side surface, the outer side surface surrounding the inner side surface, and the outer side surface paralleling the inner side surface;
a plurality of first positioning portions and a plurality of second positioning portions, located on the two first frame components; and
a plurality of third positioning portions and a plurality of fourth positioning portions, located on the two second frame components;
wherein the plurality of first positioning portions and the plurality of third positioning portions are located on the outer side surface, and the plurality of second positioning portions and the plurality of fourth positioning portions are located on the inner side surface.

11. The casing according to claim 10, wherein there is a step between the outer side surface and the inner side surface.

12. The casing according to claim 10, wherein every two of the plurality of first positioning portions, which are adjacent to each other, are spaced apart by a first distance, every two of the plurality of second positioning portions, which are adjacent to each other, are spaced apart by a second distance, every two of the plurality of third positioning portions, which are adjacent to each other, are spaced apart by the first distance, every two of the plurality of fourth positioning portions, which are adjacent to each other, are spaced apart by the second distance, and the first distance is different from the second distance.

13. The casing according to claim 10, further comprising an assembling component, wherein the assembling component has two connecting structures respectively at two ends thereof, and the two connecting structures respectively correspond to at least one of the second positioning portions located on the two first frame components.

14. The casing according to claim 13, further comprising two first connecting members, wherein the two connecting structures are two through holes, and the two first connecting members are respectively disposed through the two through holes and mounted on at least one of the second positioning portions.

15. The casing according to claim 14, further comprising a cover plate and a plurality of second connecting members, wherein the cover plate has a plurality of through holes, and the plurality of second connecting members are respectively disposed through the plurality of through holes of the cover plate and mounted on the plurality of first positioning portions and the plurality of third positioning portions.

16. The casing according to claim 10, wherein each of the first frame components is orthogonal to each of the second frame components.

17. The casing according to claim 10, wherein the plurality of first positioning portions, the plurality of second positioning portions, the plurality of third positioning portions and the plurality of fourth positioning portions are holes.

18. The casing according to claim 10, wherein the plurality of first positioning portions, the plurality of second positioning portions, the plurality of third positioning portions and the plurality of fourth positioning portions are hooks.

19. A supporting member of a casing, comprising:
a frame component, comprising:
a column part, having a first surface; and
at least one extension plate, connected to one side of the column part, and the at least one extension plate having a second surface;
a plurality of first positioning portions, located on the first surface; and
a plurality of second positioning portions, located on the second surface, wherein a distance between every two of the plurality of first positioning portions, which are adjacent to each other, is different from a distance between every two of the plurality of second positioning portions which are adjacent to each other.

20. The supporting member according to claim 19, further comprising a plurality of first side positioning portions and a plurality of second side positioning portions, wherein the quantity of the at least one extension plate is two, the two extension plates are respectively connected to two adjacent sides of the column part, the column part has a first side surface, the first side surface is connected to the first surface, one of the extension plates has the second surface, the other one of the extension plates has a second side surface, the plurality of first side positioning portions are located on the first side surface, the plurality of second side positioning portions are located on the second side surface, and a distance between every two of the plurality of first side positioning portions, which are adjacent to each other, is different from a distance between every two of the plurality of second side positioning portions which are adjacent to each other.

21. The supporting member according to claim 20, wherein the column part and the two extension plates are of a single piece which is formed by bending a sheet metal.

22. The supporting member according to claim 20, wherein the column part and the two extension plates are of a single piece which is made from an aluminum extrusion.

23. A supporting member of a casing, comprising:
a frame component, comprising:
a column part, having a first surface; and
at least one extension plate, connected to one side of the column part, the at least one extension plate having a second surface, and the second surface paralleling the first surface;
a plurality of first positioning portions, located on the first surface; and
a plurality of second positioning portions, located on the second surface.

24. The supporting member according to claim 23, wherein a distance between every two of the plurality of first positioning portions, which are adjacent to each other, is larger than a distance between every two of the plurality of second positioning portions which are adjacent to each other.

25. The supporting member according to claim 23, further comprising a plurality of first side positioning portions and a plurality of second side positioning portions, wherein the quantity of the at least one extension plate is two, the two extension plates are respectively connected to two adjacent sides of the column part, the column part has a first side surface, the first side surface is connected to the first surface, one of the extension plates has the second surface, the other one of the extension plates has a second side surface, the second side surface parallels the first side surface, and a distance between every two of the plurality of first side positioning portions, which are adjacent to each other, is different from a distance between every two of the plurality of second side positioning portions which are adjacent to each other.

26. The supporting member according to claim 25, wherein the column part and the two extension plates are of a single piece which is formed by bending a sheet metal.

27. The supporting member according to claim 25, wherein the column part and the two extension plates are of a single piece which is made from an aluminum extrusion.

28. A supporting member of a casing, comprising:
a frame component, comprising:
a hollow column; and
at least two protruding plates, respectively protruding from two different sides of the hollow column;
a plurality of first positioning portions and a plurality of second positioning portions, located on the hollow column and respectively aligned in two straight lines; and
a plurality of third positioning portions and a plurality of fourth positioning portions, located on the two protruding plates and respectively aligned in another two straight lines.
